(19) United States
(12) Patent Application Publication
(10) Pub. No.: US 2026/0156710 A1
(43) Pub. Date: Jun. 4, 2026

(54) Methods And Apparatus For Improving Connection Release Procedure In Mobile Communications

(71) Applicant: MediaTek Inc., Hsinchu City (TW)

(72) Inventors: Ren-Huang Liu, Hsinchu City (TW); Tsung-Ming Lee, Hsinchu City (TW); Yuh-Hwang You, Hsinchu City (TW)

(73) Assignee: MediaTek Inc., Hsinchu City (TW)

(21) Appl. No.: 19/392,242

(22) Filed: Nov. 18, 2025

Related U.S. Application Data
(60) Provisional application No. 63/727,714, filed on Dec. 4, 2024.

(51) Int. Cl. H04W 76/27

(52) U.S. Cl. CPC H04W 76/27

(57) ABSTRACT

Various solutions for improving a connection release procedure in mobile communications are described. A user equipment (UE) may establish a radio resource control (RRC) connection with a network node of a wireless network. The UE may receive an RRC release message from the network node. The RRC release message may comprise a cause for releasing the RRC connection. Then, the UE may determine whether to re-establish the RRC connection according to the cause.

### CROSS REFERENCE TO RELATED PATENT APPLICATION(S)

The present disclosure is part of a non-provisional application claiming the priority benefit of U.S. Application No. 63/727,714, filed 4 Dec. 2024, the content of which herein being incorporated by reference in its entirety.

### TECHNICAL FIELD

The present disclosure is generally related to mobile communications and, more particularly, to improving a connection release procedure with respect to user equipment (UE) and network apparatus in mobile communications.

### BACKGROUND

Unless otherwise indicated herein, approaches described in this section are not prior art to the claims listed below and are not admitted as prior art by inclusion in this section.

In a fifth-generation (5G)/New Radio (NR) network, the UE may establish a radio resource control (RRC) connection with a network node for transmitting or receiving data/signals. In some scenarios, the network node may determine to release the RRC connection for various reasons. The network node may transmit an RRC release message to the UE for releasing the RRC connection. However, in the current 5G/NR framework, the network node does not indicate the reason for releasing the RRC connection.

After receiving the RRC release message from the network node, the UE does not know why the network releases the RRC connection. That is, the UE has no information about the status of the network node and/or the reason for releasing the RRC connection. In such a situation, the UE may try to initiate a connection reestablishment procedure to re-establish the RRC connection. However, the network node may be in an unavailable status and does not allow the UE to access it temporarily. The network node may reject/ignore the UE's reestablishment procedure or release the RRC connection again. This may cause a service interruption on the UE. The UE is unable to connect to the network efficiently and instantly. In addition, the UE may perform unnecessary reestablishment/retry procedures to waste UE power and radio resources.

Accordingly, how to improve the connection release procedure becomes an important issue in the newly developed wireless communication network. Therefore, there is a need to provide proper schemes for notifying the UE about the reasons for connection release.

### SUMMARY

The following summary is illustrative only and is not intended to be limiting in any way. That is, the following summary is provided to introduce concepts, highlights, benefits, and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the aforementioned issue pertaining to improving a connection release procedure.

In one aspect, a method may involve an apparatus establishing, by a processor of an apparatus, an RRC connection with a network node of a wireless network. The method may also involve the apparatus receiving, by the processor, an RRC release message from the network node. The RRC release message may comprise a cause for releasing the RRC connection. The method may further involve the apparatus determining, by the processor, whether to re-establish the RRC connection according to the cause.

In another aspect, an apparatus may comprise a transceiver which, during operation, wirelessly communicates with a wireless network. The apparatus may also comprise a processor communicatively coupled to the transceiver. The processor, during operation, may perform operations comprising establishing, via the transceiver, an RRC connection with a network node of the wireless network. The processor, during operation, may also perform operations comprising receiving, via the transceiver, an RRC release message from the network node. The RRC release message may comprise a cause for releasing the RRC connection. The processor, during operation, may further perform operations determining whether to re-establish the RRC connection according to the cause.

In another aspect, a method may involve a network node establishing, by a processor of the network node of a wireless network, an RRC connection with a UE. The method may also involve the network node determining, by the processor, to release the RRC connection. The method may further involve the network node including, by the processor, a cause for releasing the RRC connection in an RRC release message. The method may further involve the network node transmitting, by the processor, the RRC release message to the UE.

It is noteworthy that, although description provided herein may be in the context of certain radio access technologies, networks and network topologies such as LTE, LTE-Advanced, LTE-Advanced Pro, 5G, NR, 5G-Advanced, Internet-of-Things (IoT), Narrow Band Internet of Things (NB-IoT), Industrial Internet of Things (IIoT), beyond 5G (B5G), and 6th Generation (6G), the proposed concepts, schemes and any variation(s)/derivative(s) thereof may be implemented in, for and by other types of radio access technologies, networks and network topologies. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale, as some components may be shown to be out of proportion than the size in actual implementation in order to clearly illustrate the concept of the present disclosure.

FIG. 1 illustrates an exemplary scenario of a communication environment in which various solutions and schemes in accordance with the present disclosure may be implemented.

FIG. 2 illustrates an exemplary scenario for an improved RRC connection release procedure in accordance with implementations of the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of another example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to improving a connection release procedure. According to the present disclosure, a number of possible solutions may be implemented separately or jointly. That is, although these possible solutions may be described below separately, two or more of these possible solutions may be implemented in one combination or another.

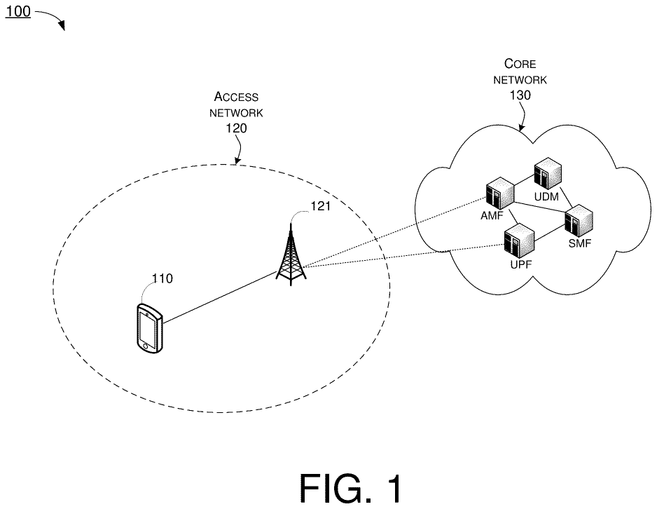

FIG. 1 illustrates an example scenario 100 of a communication environment in which various solutions and schemes in accordance with the present disclosure may be implemented. Scenario 100 involves a user equipment (UE) 110 in wireless communication with a wireless network (e.g., an LTE network, a 5G/NR network, an IoT network, or a 6G network) consisting of an access network 120 and a core network 130. The UE 110 may be a smartphone, a wearable device, an IoT device, or a tablet, etc. Alternatively, the UE 110 may be a notebook (NB) or personal computer (PC) inserted or installed with a data card which includes a modem and radio frequency (RF) transceiver(s) to provide the functionality of wireless communication. In one embodiment, the access network 120 is connected to the core network 130 by means of the NG interface, more specifically to a user plane function (UPF) by means of the NG user-plane part (NG-u), and to an access and mobility management function (AMF) by means of the NG control-plane part (NG-c). The access network 120 may include a base station (BS) 121, which may be connected to multiple UPFs/AMFs for the purpose of load sharing and redundancy. In addition, the core network 130 may include other entities, such as a session management function (SMF) and a unified data management (UDM), etc. In some embodiments, the access network 120 may include multiple BSs, each of which may provide communication coverage for a geographic coverage area where communications with the UE 110 are supported.

In scenario 100, the UE 110 may establish an RRC connection with the network node 121 of the wireless network (e.g., the access network 120 and the core network 130). For some reason, the network node 121 may determine to release the RRC connection. The network node 121 may include a cause for releasing the RRC connection in an RRC release message and transmit the RRC release message to the UE. The UE 110 may receive the RRC release message from the network node 121. The RRC release message comprises a cause for releasing the RRC connection. Then, the UE 110 may determine whether to re-establish the RRC connection according to the cause.

In some implementations, the cause for releasing the RRC connection may comprise, for example and without limitation, at least one of a base station being overloaded, a message decoded error, a message being not received, a base station internal error, an N1 or N2 connection error (e.g., N1 interface or N2 interface), a capability check failure, a capability size limitation, and a voice call being canceled or released. The message decoded error may comprise, for example and without limitation, an RRCSetupComplete decoded error. The message is not received may comprise that, for example and without limitation, a SecurityModeComplete is not received. The RRC release message may comprise a cause information element (IE) to indicate the cause for releasing the RRC connection. These causes may clearly indicate the reason that the network node decides to release the RRC connection. By providing the specific connection release cause to the UE, the UE is able to know the status of the network node and determine whether to re-establish the RRC connection according to the cause.

In some implementations, any other causes that can reflect the status (e.g., traffic/loading status, connection status, operation status, etc.) of the network node or indicate the reason for releasing a connection may be provided to the UE in response to a connection being released. The connection release cause may also be carried in other messages in addition to the RRC release message. For example, the cause may be carried in a higher-layer signaling or a layer 1(L 1 ) signaling.

After receiving the RRC release message with the cause, the UE may determine how to respond to the RRC connection release based on the cause. The UE may determine not to re-establish the RRC connection if the cause indicates that the network node is unavailable. The network will not receive a request for re-establishing the RRC connection (e.g., an RRC setup request) from the UE after transmitting the RRC release message to the UE. Specifically, the UE may determine to perform at least one of the following procedures: re-selecting another network node, barring the network node, modifying an RRC capability setting, and re-establishing the RRC connection. For example, if the cause indicates that the base station is overloaded, the UE may determine to re-select another network node. If the cause indicates that the base station has an internal error, the UE may determine to bar the network node. If the cause indicates the capability size limitation, the UE may determine to modify the RRC capability setting and re-establish the RRC connection with the same network node.

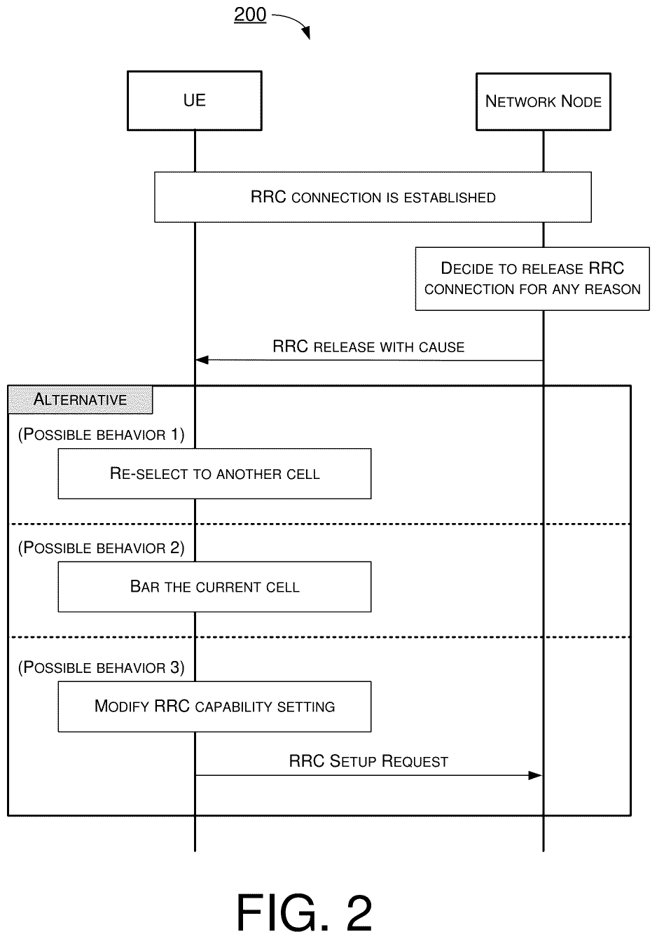

FIG. 2 illustrates an exemplary scenario 200 for an improved RRC connection release procedure in accordance with implementations of the present disclosure. In scenario 200, at first, an RRC connection is established between the UE and the network node. Then, for any reason, the network node decides to release the RRC connection. The network node transmits an RRC release message with a cause for releasing the RRC connection. The cause may be one of the causes illustrated above. After receiving the RRC release message with the cause, the UE may determine one of the possible behaviors (e.g., possible behavior 1, possible behavior 2, or possible behavior 3) according to the cause. In possible behavior 1, the UE may determine to re-select to another cell. In possible behavior 2, the UE may determine to bar the current cell. The UE may initiate a timer for barring the current cell. In possible behavior 3, the UE may determine to modify the RRC capability setting and transmit an RRC setup request to the network node for re-establishing the RRC connection with the network node. The network node may receive the RRC setup request with the RRC capability setting being modified from the UE.

In some implementations, the improved RRC connection release procedure proposed in the present disclosure may be applied to a 5G NR network or a next-generation network (e.g., 6G network). Accordingly, by providing the cause/reason for releasing an RRC connection, the UE can know the status of the network node and perform proper procedures based on the cause. If the current network node is unavailable for providing services, the UE can re-select another network node instantly and will not waste UE power and radio resources trying to re-connect to the current cell. Thus, the UE is able to select a proper network node efficiently for establishing an RRC connection. The user experience can also be improved.

### Illustrative Implementations

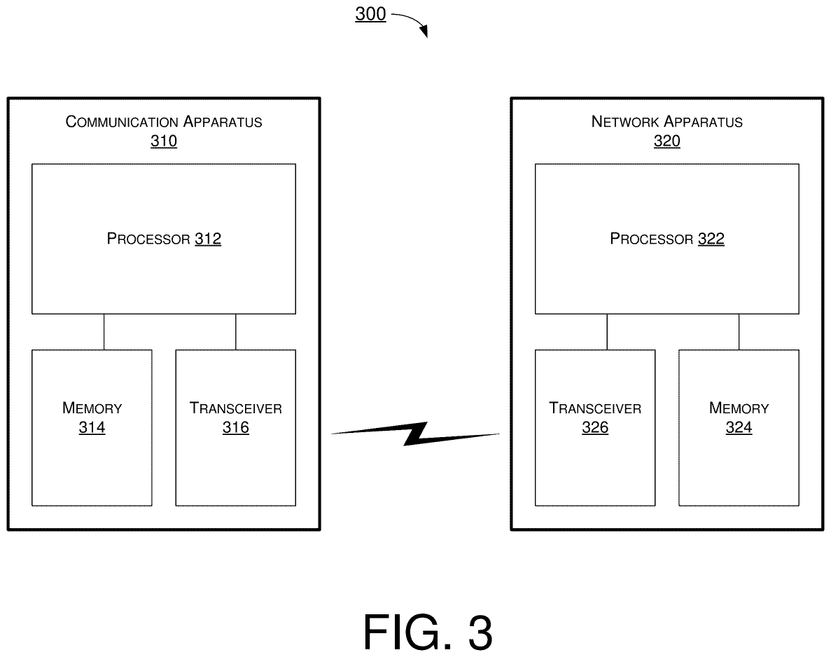

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to improving a connection release procedure in mobile communications, including scenarios/schemes described above as well as process 400 and process 500 described below.

Communication apparatus 310 may be a part of an electronic apparatus, which may be a UE such as a portable or mobile apparatus, a wearable apparatus, a wireless communication apparatus, or a computing apparatus. For instance, communication apparatus 310 may be implemented in a smartphone, a smartwatch, a personal digital assistant, a digital camera, or a computing equipment such as a tablet computer, a laptop computer, or a notebook computer. Communication apparatus 310 may also be a part of a machine type apparatus, which may be an IoT, NB-IoT, or IIoT apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of a network apparatus, which may be a network node such as a satellite, a base station, a small cell, a router, a gateway, or other network element. For instance, network apparatus 320 may be implemented in an eNodeB in an LTE network, in a gNB in a 5G/NR, IoT, NB-IoT or IIoT network or in a satellite or base station in a 6G network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including the proposed connection release procedure in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE and network apparatus 320 is implemented in or as a network node of a communication network.

### Illustrative Processes

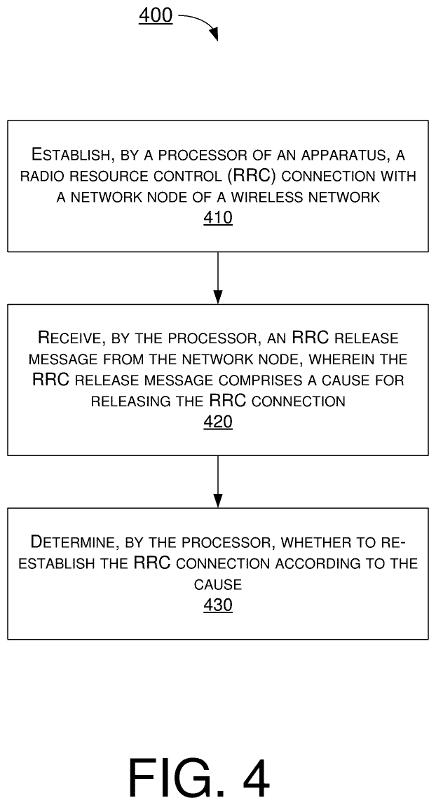

FIG. 4 illustrates an example process 400 in accordance with an implementation of the present disclosure. Process 400 may be an example implementation of above scenarios/schemes, whether partially or completely, with respect to the improved connection release procedure of the present disclosure. Process 400 may represent an aspect of implementation of features of communication apparatus 310. Process 400 may include one or more operations, actions, or functions as illustrated by one or more of blocks 410 to 430. Although illustrated as discrete blocks, various blocks of process 400 may be divided into additional blocks, combined into fewer blocks, or eliminated, depending on the desired implementation. Moreover, the blocks of process 400 may be executed in the order shown in FIG. 4 or, alternatively, in a different order. Process 400 may be implemented by communication apparatus 310 or any suitable UE or machine type devices. Solely for illustrative purposes and without limitation, process 400 is described below in the context of communication apparatus 310. Process 400 may begin at block 410.

At block 410, process 400 may involve processor 312 of communication apparatus 310 establishing, via transceiver 316, an RRC connection with a network node of a wireless network. Process 400 may proceed from block 410 to block 420.

At block 420, process 400 may involve processor 312 of communication apparatus 310 receiving, via transceiver 316, an RRC release message from the network node. The RRC release message may comprise a cause for releasing the RRC connection. Process 400 may proceed from block 420 to block 430.

At block 430, process 400 may involve processor 312 of communication apparatus 310 determining whether to re-establish the RRC connection according to the cause.

In some implementations, process 400 may involve processor 312 of communication apparatus 310 performing, according to the cause, at least one of: re-selecting another network node, barring the network node, modifying an RRC capability setting, and re-establishing the RRC connection.

In some implementations, process 400 may involve processor 312 of communication apparatus 310 transmitting, via transceiver 316, an RRC setup request to the network node in an event that the RRC capability setting is modified.

In some implementations, process 400 may involve processor 312 of communication apparatus 310 determining not to re-establish the RRC connection according to the cause.

In some implementations, the wireless network may comprise a 6G network or a next-generation network.

In some implementations, the cause may indicate at least one of: i) a base station is overloaded; ii) a message decoded error; iii) a message is not received; iv) a base station internal error; v) an N1 or N2 connection error; vi) a capability check failure; vii) a capability size limitation; and viii) a voice call is canceled or released.

In some implementations, the message decoded error may comprise an RRCSetupComplete decoded error. The message is not received may comprise that a SecurityModeComplete is not received.

In some implementations, the RRC release message may comprise a cause information element (IE) to indicate the cause for releasing the RRC connection.

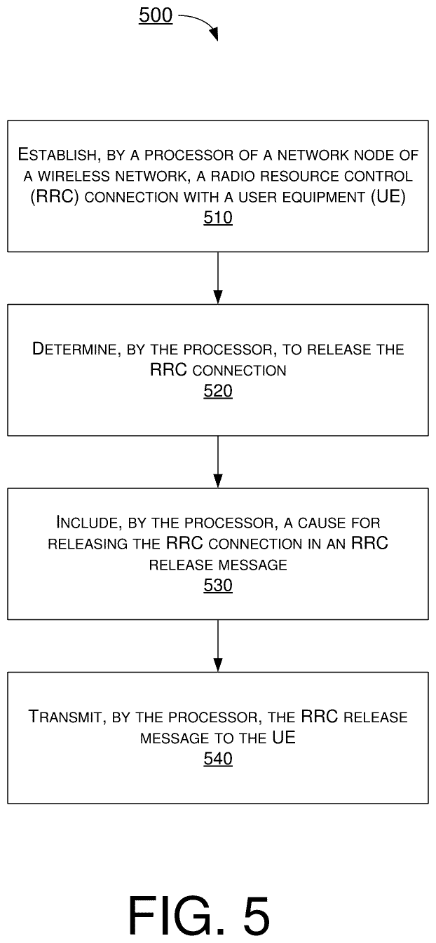

FIG. 5 illustrates an example process 500 in accordance with an implementation of the present disclosure. Process 500 may be an example implementation of above scenarios/schemes, whether partially or completely, with respect to the improved connection release procedure of the present disclosure. Process 500 may represent an aspect of implementation of features of network apparatus 320. Process 500 may include one or more operations, actions, or functions as illustrated by one or more of blocks 510 to 540. Although illustrated as discrete blocks, various blocks of process 500 may be divided into additional blocks, combined into fewer blocks, or eliminated, depending on the desired implementation. Moreover, the blocks of process 500 may be executed in the order shown in FIG. 5 or, alternatively, in a different order. Process 500 may be implemented by network apparatus 320 or any suitable network nodes or base stations. Solely for illustrative purposes and without limitation, process 500 is described below in the context of network apparatus 320. Process 500 may begin at block 510.

At block 510, process 500 may involve processor 322 of network apparatus 320 establishing, via transceiver 326, an RRC connection with a UE. Process 500 may proceed from block 510 to block 520.

At block 520, process 500 may involve processor 322 of network apparatus 320 determining to release the RRC connection. Process 500 may proceed from block 520 to block 530.

At block 530, process 500 may involve processor 322 of network apparatus 320 including a cause for releasing the RRC connection in an RRC release message. Process 500 may proceed from block 530 to block 540.

At block 540, process 500 may involve processor 322 of network apparatus 320 transmitting, via transceiver 326, the RRC release message to the UE.

In some implementations, network apparatus 320 may be a network node of a 6G network or a next-generation network.

In some implementations, process 500 may involve processor 322 of network apparatus 320 receiving, via transceiver 326, an RRC setup request with an RRC capability setting being modified from the UE.

In some implementations, network apparatus 320 does not receive an RRC setup request from the communication apparatus 310 after transmitting the RRC release message to communication apparatus 310.

In some implementations, the cause may indicate at least one of: i) a base station is overloaded; ii) a message decoded error; iii) a message is not received; iv) a base station internal error; v) an N1 or N2 connection error; vi) a capability check failure; vii) a capability size limitation; and viii) a voice call is canceled or released.

In some implementations, the message decoded error may comprise an RRCSetupComplete decoded error. The message is not received may comprise that a SecurityModeComplete is not received.

In some implementations, the RRC release message may comprise a cause IE to indicate the cause for releasing the RRC connection.

### Additional Notes

The herein-described subject matter sometimes illustrates different components contained within, or connected with, different other components. It is to be understood that such depicted architectures are merely examples, and that in fact, many other architectures can be implemented that achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
establishing, by a processor of an apparatus, a radio resource control (RRC) connection with a network node of a wireless network;
receiving, by the processor, an RRC release message from the network node, wherein the RRC release message comprises a cause for releasing the RRC connection; and
determining, by the processor, whether to re-establish the RRC connection according to the cause.

2. The method of claim 1, wherein the determining of whether to re-establish the RRC connection according to the cause further comprises:
performing, according to the cause, at least one of:
re-selecting another network node;
barring the network node;
modifying an RRC capability setting; and
re-establishing the RRC connection.

3. The method of claim 2, further comprising:
transmitting, by the processor, an RRC setup request to the network node in an event that the RRC capability setting is modified.

4. The method of claim 1, wherein the determining of whether to re-establish the RRC connection according to the cause further comprises:
determining not to re-establish the RRC connection according to the cause.

5. The method of claim 1, wherein the cause indicates at least one of:
a base station is overloaded;
a message decoded error;
a message is not received;
a base station internal error;
an N1 or N2 connection error;
a capability check failure;
a capability size limitation; and
a voice call is canceled or released.

6. The method of claim 5, wherein the message decoded error comprises an RRCSetupComplete decoded error, and wherein the message is not received comprises that a SecurityModeComplete is not received.

7. The method of claim 1, wherein the RRC release message comprises a cause information element (IE) to indicate the cause for releasing the RRC connection.

8. An apparatus, comprising:
a transceiver which, during operation, communicates wirelessly; and
a processor communicatively coupled to the transceiver such that, during operation, the processor performs operations comprising:
establishing, via the transceiver, a radio resource control (RRC) connection with a network node of a wireless network;
receiving, via the transceiver, an RRC release message from the network node, wherein the RRC release message comprises a cause for releasing the RRC connection; and
determining whether to re-establish the RRC connection according to the cause.

9. The apparatus of claim 8, wherein, in determining whether to re-establish the RRC connection according to the cause, the processor is further configured to perform operations comprising:
performing, according to the cause, at least one of:
re-selecting another network node;
barring the network node;
modifying an RRC capability setting; and
re-establishing the RRC connection.

10. The apparatus of claim 9, wherein the processor is further configured to perform operations comprising:
transmitting, via the transceiver, an RRC setup request to the network node in an event that the RRC capability setting is modified.

11. The apparatus of claim 8, wherein, in determining whether to re-establish the RRC connection according to the cause, the processor is further configured to perform operations comprising:
determining not to re-establish the RRC connection according to the cause.

12. The apparatus of claim 8, wherein the cause indicates at least one of:
a base station is overloaded;
a message decoded error;
a message is not received;
a base station internal error;
an N1 or N2 connection error;
a capability check failure;
a capability size limitation; and
a voice call is canceled or released.

13. The apparatus of claim 12, wherein the message decoded error comprises an RRCSetupComplete decoded error, and wherein the message is not received comprises that a SecurityModeComplete is not received.

14. The apparatus of claim 8, wherein the RRC release message comprises a cause information element (IE) to indicate the cause for releasing the RRC connection.

15. A method, comprising:
establishing, by a processor of a network node of a wireless network, a radio resource control (RRC) connection with a user equipment (UE);
determining, by the processor, to release the RRC connection;
including, by the processor, a cause for releasing the RRC connection in an RRC release message; and
transmitting, by the processor, the RRC release message to the UE.

16. The method of claim 15, further comprising:
receiving, by the processor, an RRC setup request with an RRC capability setting being modified from the UE.

17. The method of claim 15, wherein the network node does not receive an RRC setup request from the UE after transmitting the RRC release message to the UE.

18. The method of claim 15, wherein the cause indicates at least one of:
a base station is overloaded;
a message decoded error;
a message is not received;
a base station internal error;
an N1 or N2 connection error;
a capability check failure;
a capability size limitation; and
a voice call is canceled or released.

19. The method of claim 18, wherein the message decoded error comprises an RRCSetupComplete decoded error, and wherein the message is not received comprises that a SecurityModeComplete is not received.

20. The method of claim 15, wherein the RRC release message comprises a cause information element (IE) to indicate the cause for releasing the RRC connection.
